(19) United States
(12) Patent Application Publication
(10) Pub. No.: US 2008/0105344 A1
(43) Pub. Date: May 8, 2008

(54) Tire having an illuminated sidewall

(76) Inventors: Robert Allen Losey, Kent, OH (US); Junling Zhao, Hudson, OH (US); John Steven Attinello, Uniontown, OH (US); Jacklyn Lee Downing, Cleveland Heights, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/593,815

(22) Filed: Nov. 7, 2006

(51) Int. Cl. B60C 19/00

(52) U.S. Cl. 152/152.1

(57) ABSTRACT

An electro-luminescent device is affixed to a tire sidewall and powered by a power source affixed to the wheel or tire. Wire(s) within the device in a preferred configuration emit a light in one or more colors in response to energization by the power source. The electro-luminescent display may be energized by appropriate circuit drivers to flash and may be activated to flash with other triggers such as car alarm systems, audio output, car locators, etc.

### FIELD OF THE INVENTION

The invention relates generally to an illumination system for a tire and, more specifically, to a tire having a powered illuminated sidewall.

### BACKGROUND OF THE INVENTION

In various applications, it is desirable to provide illumination to a vehicle wheel for the purpose of safety or to provide a special effect. It is known to utilize reflectors to the wheels of vehicles to make the vehicles more visible. Such reflectors, however, are only visible within a narrow range of incident light. Situated outside of the path of a light source, such devices are not noticeable.

It is further known to use incandescent lights on the exterior of a vehicle to replace reflective devices. Such lighting systems, however, are generally not suitable for incorporation into a wheel of the vehicle due to the size of the incandescent lights, the power requirements needed to power the lighting system, and/or the commuting requirements to provide power to the lighting system.

Other types of lighting systems and arrangements likewise have proven inadequate for illuminating a vehicle wheel because of cost, durability, and flexibility limitations of such systems. Adapting the wheel of a vehicle post-vehicle manufacture to provide illumination capability can be cumbersome and expensive, whereby limiting the commercial appeal of such systems.

Accordingly, there is a need for a means for providing a low-cost, visual means for differentiating the wheel area of vehicle for a consumer. Such a system should be flexible in order to afford customized visual differentiation in a variety of applications. Moreover, a suitable system will be capable of convenient retrofit application to existing vehicles at an acceptable level of cost.

### SUMMARY OF THE INVENTION

The present invention in one aspect is directed to an illuminated sidewall of a tire. An electro-luminescent wire(s) is affixed to a tire sidewall and powered by a power source affixed remotely to the wheel or tire. A battery power source may be employed, mounted to an externally accessible surface of the tire rim from which batteries may be replaced as necessary. The wire(s) emit a light in one or more colors in response to energization by the power source. According to a further aspect, the wire(s) may be in the form of a panel of a preferred design, whereby illumination of the panel will create a pre-selected user preferred design or image in one or more colors. Pursuant to another aspect, electro-luminescent material is selected for attachment to a tire sidewall in preselected shapes and sizes in a preferred form such as but not limited to a logo to create a user specific design. In another aspect of the invention, the electro-luminescent display is energized by circuit drivers to flash and may be activated to flash with other triggers such as car alarm systems, audio output, car locators, etc.

According to a further aspect of the invention, a tire is adapted to receive an electro-luminescent device in a post-cure adhesive attachment by providing a recess in the tire sidewall. Yet a further aspect of the invention utilizes a coating over the electro-luminescent device to render the device more durable during its service lifetime.

### BRIEF DESCRIPTION OF THE DRAWINGS

The invention will be described by way of example and with reference to the accompanying drawings in which:

FIG. 1 is a perspective view of a representative tire with an electro-luminescent device attached thereto;

FIG. 2 is an exploded perspective view of the tire and electro-luminescent device;

FIG. 3 is a transverse section view of the tire and device taken along the line 3-3 of FIG. 1;

FIG. 4 is an enlarged view of the device and tire sidewall;

FIG. 5 is an enlarged sectional view of the light emitting portion of the device and tire;

FIG. 6 is an enlarged sectional view of a light emitting device portion alternatively mounted to a tire sidewall;

FIG. 7 is an enlarged sectional view of a plurality of light emitting device portions arranged on a tire sidewall.

### DETAILED DESCRIPTION OF THE INVENTION

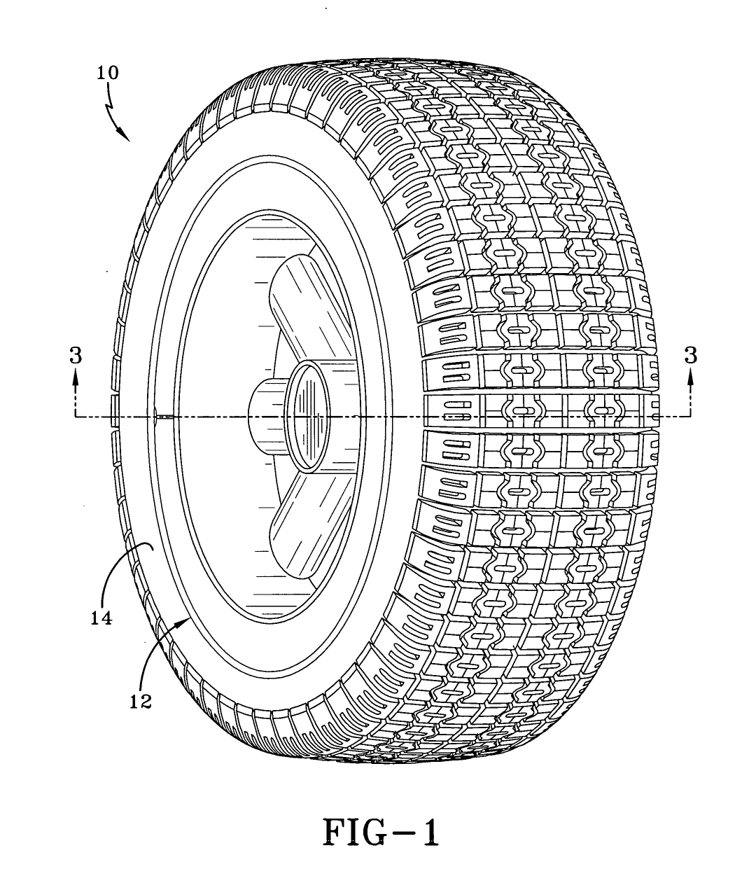

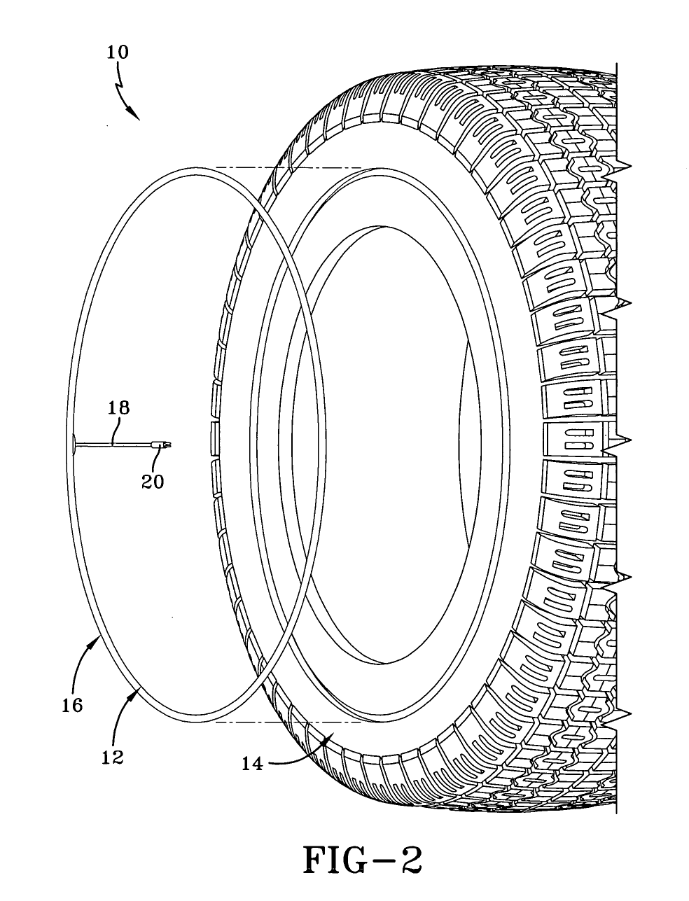

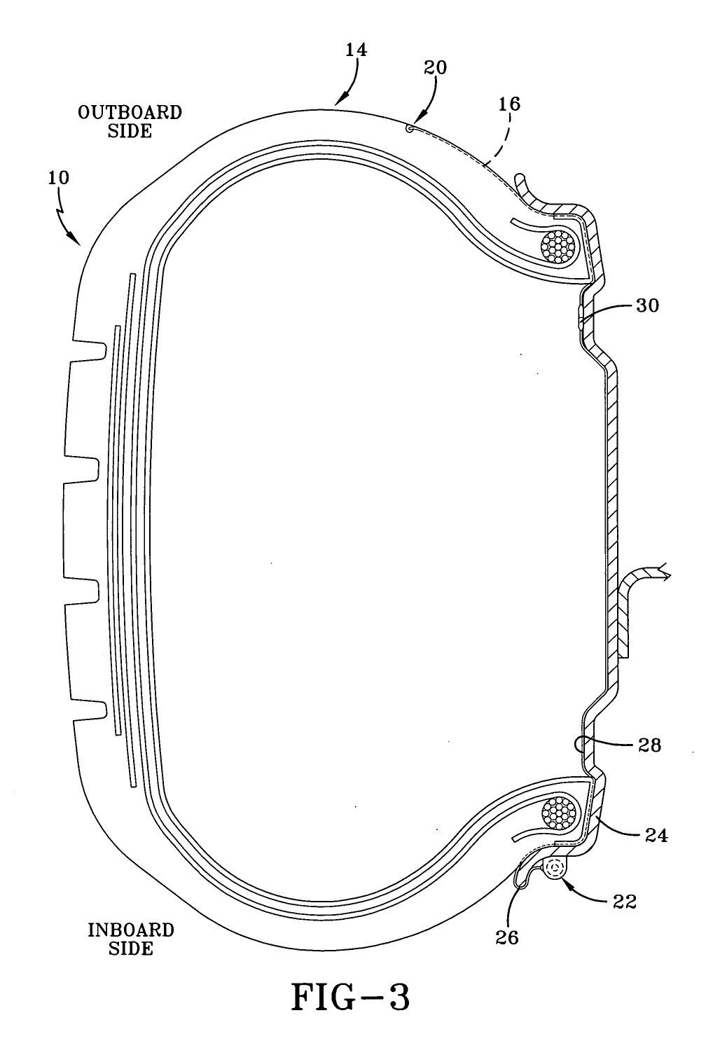

Referring to FIGS. 1, 2, and 3, a tire 10 is shown having an electro-luminescent device 12 attached to a tire sidewall 14. The device 12 includes a wire 16, electrical conductors 18 coupled to the wire 16, and a terminal electrical connector 20. Wire 16 in device 12 is of a type that glows when powered by compact drivers, giving off light of a particular color. Such assemblies are commercially available, such as from Solution Industries of 1704 Seamist Drive, Houston, Tex. The wire is phosphor coated which emits a light when energized. Different color plastics jackets may surround the phosphor coated wire and be used to change the color of the emitted light. The electro-luminescent medium, while shown in the embodiment of FIGS. 1-3 in the form of a wire 16, is available in a variety of shapes and sizes and may be configured according to the invention as a precut or shaped panel that emits light of various colors when powered.

Accordingly, device 12 may be affixed to the tire sidewall 14 in a preferred configuration such as an annular loop (shown), and/or a panel (shown schematically in FIG. 7) and utilized to light the sidewall with various colors. The configuration employed on the sidewall may include personalized lettering, designs, or logos and be used to customize a user's tires on a vehicle or to convey commercial information to other viewers.

Moreover, circuitry may be incorporated that drive the light panels or wires in a flashing sequence such that the tire sidewall lights flash intermittently. In some applications, the sidewall lights may be made to flash in coordinated fashion with other vehicle systems such as car alarm systems, audio output (music and/or other sounds), car locator systems, etc. The wires 16 may be round in section as shown or of flat configuration, depending on the application and user preference.

The device 12 is powered by a power source 22. Power source 22 may be mounted to the tire but preferably will be mounted to the rim 24 of a wheel by means of a clamping device 26. The power source 22 may utilize batteries that can be accessed and replaced as needed over time. As shown, the power source 22 includes electrical leads 28 that terminate in an electrical connector 30 that is configured to mate with the connector 20 of electro-luminescent device 12. The power source 22 may, as discussed above, include control drivers for intermittently powering the light conductor(s) 16, whereby causing the conductor(s) to flash in regular or irregular intervals, or in conjunction with other vehicle systems.

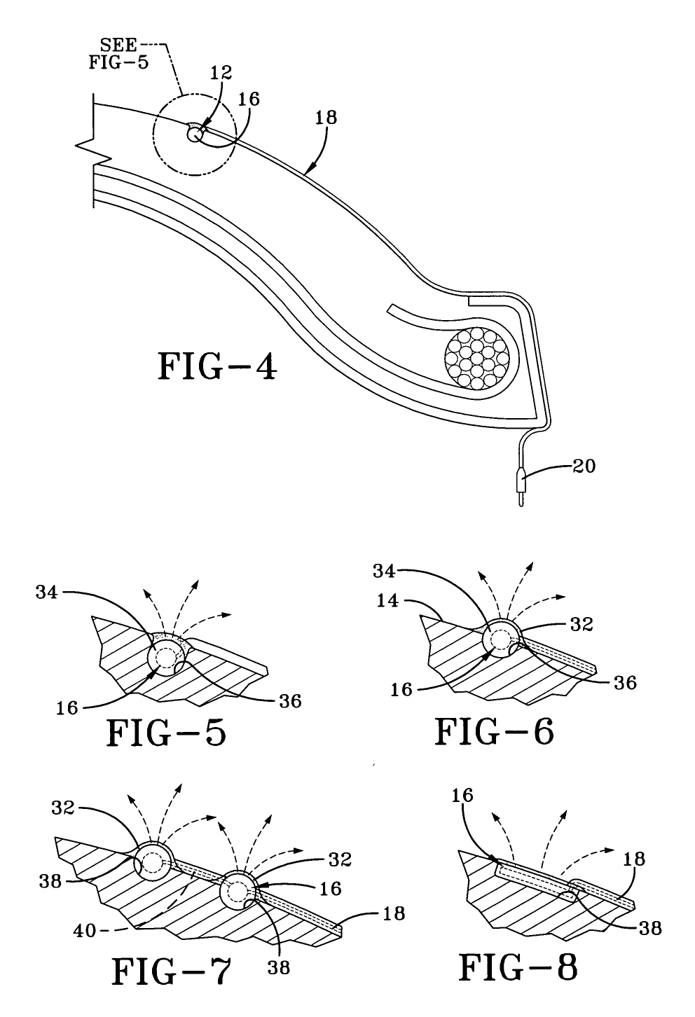

FIGS. 4 and 5 show one form of attachment of the device conductor 16 to a tire sidewall 14. The conductor 16 is attached by means of a suitable commercially available adhesive 32 such as an epoxy. As shown, the conductor 16 may further be at least partially covered by a clear commercially available coating or sealant 34 that can function to aid in wire durability over time. The device 12 may be added in retrofit manner to existing tires or as part of an original tire manufacturing line. A recess or groove 36 may be formed into a tire sidewall as shown. The electro-luminescent wire 16 is generally of small size, as small as 0.9 mm. Due to the variety in wire 16 size, the recess or groove 36 does not have to be very large. Using a conventional adhesive, the wire 16 can be attached in a post-cure procedure and coated with a clear sealant as a protective layer. For example, without any intention to delimit the invention, a clear urethane may be used to seal and weatherproof the electro-luminescent wire 16 in the sidewall 14.

FIG. 6 shows a shallower groove or recess 38, resulting in the wire 16 protruding from the sidewall 14 a greater extent. The configuration of the recess 38, electro-luminescent wire 16 relative to the sidewall 14 may be designed as required for the desired visual effect.

FIG. 7 shows a multi-wire representation in which multiple electro-luminescent wires 16, 40 are deployed within a tire sidewall 14, such as in a panel or logo configuration. Each wire 16, 40 may be separately wired to a remote power source and controllers in order for the illumination of each wire to be separately controlled. Different colors may be achieved through the selection of wires in order to create a desired visual effect.

From the foregoing, it will be appreciated that the subject invention uses electro-luminescent wires and/or panels to illuminate a tire sidewall in a desired pattern. Such wires and/or panels create lighted designs and images on the sidewalls in preselected shapes, sizes, and colors. The electro-luminescent material is available in a variety of shapes and sizes and may be precut or shaped into panels for affixation to a tire sidewall. For example, small panels can be cut and configured with school or corporate logos and images that light up. Such displays may be made to flash in a variety of sequences to further add visual appeal and attention. Modules may be added to permit the lights to flash with other triggers such as car alarm systems, audio output (music, sounds, etc.) car locators. The invention therefore provides a low cost means for achieving visual customization and differentiation of tires and vehicles for the consumer. Color and shape customization is possible creating marketing opportunities in specific markets such as school and company logos. Choices in colors, size and layout of the sidewall illumination may be made by the tire or vehicle manufacturer, the post-manufacture vehicle fleet owner, or the consumer.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A tire comprising:
a tire sidewall;
an electro-luminescent device affixed to the tire sidewall;
a power source coupled to energize the electro-luminescent device.

2. A tire according to claim 1, wherein the electro-luminescent device comprises at least one wire.

3. A tire according to claim 2, wherein the tire sidewall includes a recess receiving the at least one wire at least partially therein.

4. A tire according to claim 3, wherein the recess is incorporated into the tire with the tire in a pre-cure stage of manufacture.

5. A tire according to claim 3, wherein the at least one wire is secured to the tire sidewall by adhesive.

6. A tire according to claim 3, wherein the at least one wire is at least partially covered with a protective coating.

7. A tire according to claim 1, wherein further comprising circuit drivers for selectively energizing and de-energizing the electro-luminescent device in a programmed intermittent pattern.

8. A tire according to claim 1, wherein further comprising circuit drivers for energizing and de-energizing the electro-luminescent device in coordination with at least one vehicle functional system.

9. A tire according to claim 8, wherein the at least one vehicle functional system is taken from the group: car alarm system, car audio output system, car locator system.

10. A tire according to claim 1, wherein the electro-luminescent device forms a panel of a pre-selected design.

11. A tire according to claim 10, wherein the pre-selected design is a logo.

12. A tire according to claim 10, wherein the electro-luminescent device comprises a plurality of wires producing a plurality of colors when energized by the power source.

13. A tire according to claim 1, wherein the electro-luminescent device includes at least one electrical conductor having a connector affixed to a remote end coupling with the power source.

14. A tire according to claim 13, wherein the power source is attached to a wheel supporting the tire.

15. A tire according to claim 14, wherein the power source is attached to an externally accessible surface of the wheel supporting the tire and includes a conductor extending from the power source along an interior of the wheel rim to a coupled engagement with the electro-luminescent conductor connector.
